(19) United States
(12) Patent Application Publication
(10) Pub. No.: US 2024/0266850 A1
(43) Pub. Date: Aug. 8, 2024

(54) MODULAR CHARGING SYSTEM

(71) Applicants: DAIMLER TRUCK AG, Leinfelden-Echterdingen (DE); DAIMLER TRUCK NORTH AMERICA LLC, Portland, OR (US)

(72) Inventors: Timothy J ROBERSON-HAMLIN, Portland, OR (US); Nathan A. HILL, Sherwood, OR (US); Adam MOREY, Gladstone, OR (US)

(21) Appl. No.: 18/289,322

(22) PCT Filed: May 3, 2022
(86) PCT No.: PCT/US2022/027398

§ 371 Date: Nov. 2, 2023

Related U.S. Application Data
(60) Provisional application No. 63/183,223, filed on May 3, 2021.

(51) Int. Cl. H02J 7/00; B60L 53/302; H02J 7/04

(52) U.S. Cl. CPC H02J 7/0042; B60L 53/302; H02J 7/04

(57) ABSTRACT

A modular charging station includes at least one lane module comprising a roof module and at least two vertical support columns coupling the roof module to ground. The charging station also includes a switch gear configured to receive alternating current voltage from a power grid. The charging station further includes a power unit configured to convert the alternating current voltage to direct current voltage. At least one power dispenser is coupled to the power unit and configured to supply the direct current voltage to a commercial vehicle. At least the power unit is arranged on the roof module.

### BACKGROUND

### Technical Field

Embodiments of the disclosed subject matter generally relate to charging systems for commercial vehicles, and more specifically to modular charging systems.

### Discussion of the Background

Solutions addressing the long-term environmental effects of vehicles powered by gasoline or diesel internal combustion engines have focused on reducing the amount of harmful exhaust gasses produced by these engines. These effects can also be addressed by transitioning from gasoline or diesel to a more environmentally-friendly fuel source, such as hydrogen or electricity. Although there has been extensive development of hydrogen fuel cells and battery-powered electric motors, the lack of refueling infrastructure prevents widespread adoption of alternatives to gasoline and diesel engines.

One solution is to employ the existing gasoline and diesel infrastructure to support alternative fuel technologies. The most promising solution for reusing the existing gasoline and diesel infrastructure is in connection with battery-powered vehicles because these vehicles can be charged using commonly-available electrical lines, whereas hydrogen requires specialized storage tanks and dispensers. In the United States conventional electric charging stations operate using alternating current (AC) Level 1 (using a standard 120 volt residential power supply) or AC Level 2 (using a standard 240 volt residential or 208 volt commercial power supply). The power generated using these voltages is sufficient for timely recharging of a battery-powered passenger vehicle, and thus adding electrical charging stations for passenger vehicles can be as simple as installing one or more charging dispensers and connecting them to a conventional residential or commercial power supply, such as by using a conventional three-prong plug and outlet.

Larger vehicles, such as commercial vehicles (e.g., busses, tractor-trailers, etc.), require significantly more power for a timely recharging due to the significantly larger batteries required for these commercial vehicles. Accordingly, charging stations for commercial vehicles cannot simply be plugged into a conventional power outlet but instead requires a direct connection to the power grid that is separate and apart from the connection that provides the conventional 120/220 volts (or 208 volts). For example, a typical tractor-trailer battery would take approximately 264 hours to completely recharge with an input of 120 volts at 1.8 KW, whereas it would only require 25 hours with an input of 240 volts at 19 KW. Although it would be theoretically possible to provide high power alternating current charging for a vehicle, the alternating current to direct current power conversion would have to occur within the vehicle, which would not be practical because the additional weight for this power conversion could be approximately 1,000 lbs. (˜453.59 kg) to charge at 1 MW.

One solution for charging commercial vehicles is illustrated in FIG. 1, which involves arranging the charging system at the periphery of a property. Specifically, a transformer 105 is coupled to an electrical pole 110 of an electrical power grid via underground electrical wire 125. The transformer 105 is coupled to a switch gear 115, which in turn is coupled to a power unit 120 via underground electrical wires 130. The transformer 105 reduces an alternating current line voltage from the power grid to a lower voltage alternating current. The switch gear 115 operates as a circuit breaker. The power unit 120 converts the lower voltage alternating current to direct current. As illustrated, the power unit 120 is coupled, via electrical lines 130, to a number of power dispensers 135 (only one of which is labeled). Although electrical wires 125 and 130 are underground, the electrical wires 125 and 130 are illustrated using solid lines for ease of understanding and this should not be understood as the electrical wires 125 and 130 being arranged above ground, which is a safety hazard and prohibited by governmental regulations in many jurisdictions. Further, the portion of power line 125 traveling down the electrical pole 110 is often surrounded by a pipe.

The recharging arrangement illustrated in FIG. 1 is particularly inconvenient because it requires the commercial vehicles to back into a parking space in order to charge. Moreover, as illustrated in FIG. 1, the trailer of a tractor-trailer must first be detached from the tractor in order to charge the battery located in the tractor portion of the tractor-trailer; otherwise, the parking space must be made long enough to accommodate the entire tractor-trailer and the power dispenser 135 would have to be moved further away from the curb to where the tractor of the fully-assembled tractor-trailer would be located. This then would require separate parking spaces for tractor-trailers and smaller commercial vehicles, and also would consume valuable real estate. Thus, the arrangement in FIG. 1 introduces delays into the charging process due to the requirement to back into the parking space, as well as the detachment of the trailer for tractor-trailers. These delays increase the overall time required to recharge the commercial vehicle, and thus hampers adoption of this technology. It is expected that adoption of rechargeable vehicle technology will require the entire charging process, including the parking of the commercial vehicle, to be performed in approximately 30 minutes.

Another alternative is illustrated in FIG. 2, which in contrast to FIG. 1 employs underground power cables. In the illustration of FIG. 2, the transformer, switch gear, and power unit are arranged in a single housing 205 (only one of which is labeled). Thus, the power unit inside of housing 205 is coupled, via underground power cables (not illustrated), to the one or more power dispensers 210 (only one of which is labeled). This solution requires extensive modifications to the infrastructure, including trenching, laying the power cables, covering the power cables with cement/asphalt, etc. Moreover, areas where there are power cables that a commercial vehicles may travel over may require additional reinforcing to withstand the weight of the commercial vehicles. Further, the equipment supplying the charging dispensers with electricity from the power grid at a sufficient voltage for charging commercial vehicles can be quite large and is typically arranged on a newly-laid concrete slab and surrounded by protective structures, such as bollards, to prevent vehicles from damaging the electrical supply equipment, which further increases the costs of the charging system.

The extensive modifications currently required for adding charging stations for commercial vehicles also presents a conflict between cost and demand. It is expected that the number of electric-powered commercial vehicles will be relatively small for a number of years before a larger adoption occurs. Thus, adding charging stations will either involve building a large amount of excess electrical capacity between the power grid and the charging dispenser to accommodate future growth or building to existing power demands or slightly above existing power demands. Building excess capacity requires absorbing the costs of this excess capacity over a period of time, which can be quite expensive and may not be offset by the revenues collected based on the existing capacity. Building to existing power demands or slightly above existing power demands is, in the short-term, cost-effective because all or almost all of the capacity is being used for revenue generation, however building out additional capacity as demand increases requires similar extensive modifications as the initial installation, including trenching, laying additional power lines, etc.

Thus, there is a need for an electrical charging station for commercial vehicles that does not require extensive modifications to existing infrastructure and that can cost-effectively accommodate both current and future power demands.

### SUMMARY

In accordance with embodiments, a modular charging station includes at least one lane module comprising a roof module and at least two vertical support columns coupling the roof module to ground. The charging station also includes a switch gear configured to receive alternating current voltage from a power grid. The charging station further includes a power unit configured to convert the alternating current voltage to a direct current voltage and at least one power dispenser coupled to the power unit and configured to supply the direct current voltage to a commercial vehicle. At least the power unit is arranged on the roof module.

In accordance with further embodiments there is a method for producing a modular charging station. At least one lane module comprising a roof module and at least two vertical support columns is installed by affixing the at least two vertical support columns to ground and affixing the roof module on top of the at least two vertical support columns. At least a power unit is arranged on the roof module. The power unit converts alternating current voltage to a direct current voltage. At least one power dispenser is installed on the ground and underneath the roof module. The power unit and the at least one power dispenser are electrically coupled to each other. A switch gear is electrically coupled to the power unit. The switch gear is electrically coupled to a power grid so that the switch gear receives alternating current voltage from the power grid and provides the alternating current voltage to the power unit.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a diagram of a conventional commercial vehicle charging system;

FIG. 2 is a diagram of another conventional commercial vehicle charging system;

FIG. 3 is a diagram of a modular charging system for commercial vehicles according to embodiments;

FIGS. 4A-4D are diagrams of electrical components of a modular charging system according to embodiments;

FIGS. 5A and 5B are diagrams of components of a modular charging system according to embodiments;

FIG. 6 is a diagram of a modular charging system for commercial vehicles according to embodiments;

FIGS. 7A and 7B are flowcharts of methods for making a modular charging system according to embodiments;

FIGS. 8-8H are schematic diagrams of methods of making a modular charging system according to embodiments;

FIG. 9 is a flowchart of a method of expanding a modular charging system according to embodiments;

FIGS. 10A-10L are schematic diagrams of methods of making a modular charging system according to embodiments;

FIG. 11 is a diagram of a modular charging system for commercial vehicles according to embodiments;

FIGS. 12A-12D are front, top, and side perspective views of a modular charging system for commercial vehicles according to embodiments;

FIGS. 13A-13D are front, top, and side perspective views of a modular charging system for commercial vehicles according to embodiments;

FIGS. 14A-14D are front, top, and side perspective views of a modular charging system for commercial vehicles according to embodiments; and

FIGS. 15A-15D are front, top, and side perspective views of a modular charging system for commercial vehicles according to embodiments.

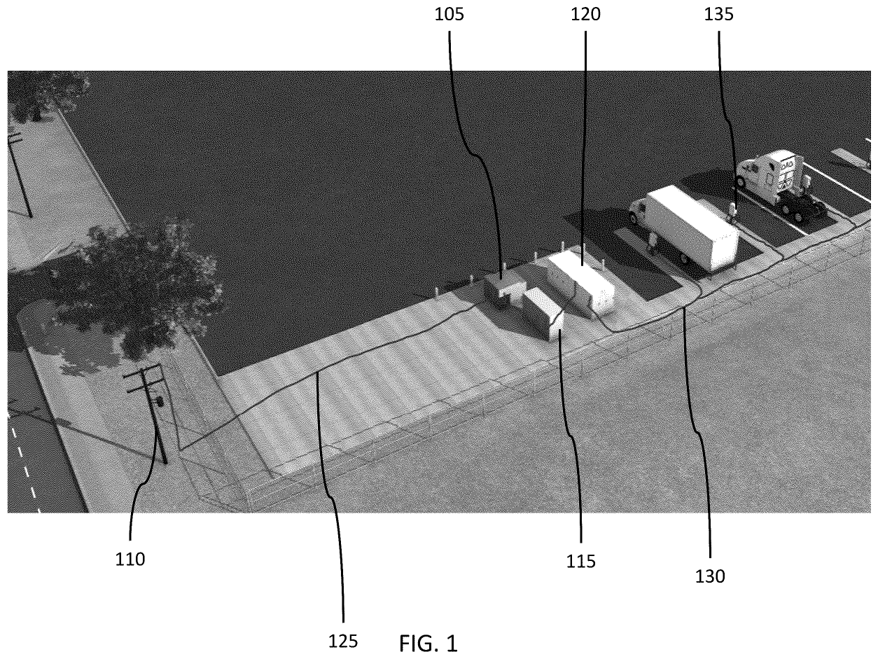

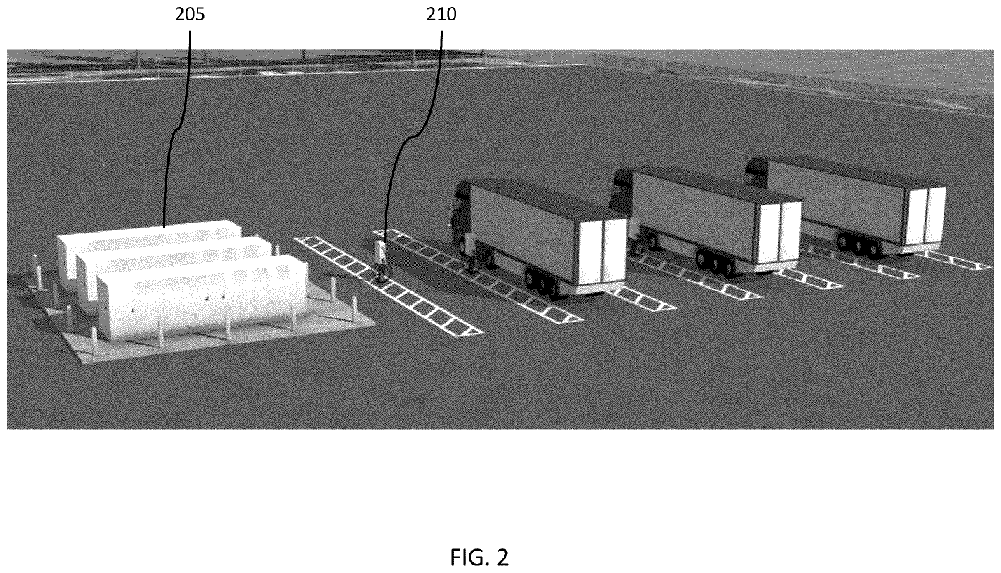

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of modular charging stations for commercial vehicles. However, the disclosed modular charging stations can also be employed with passenger vehicles as well.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

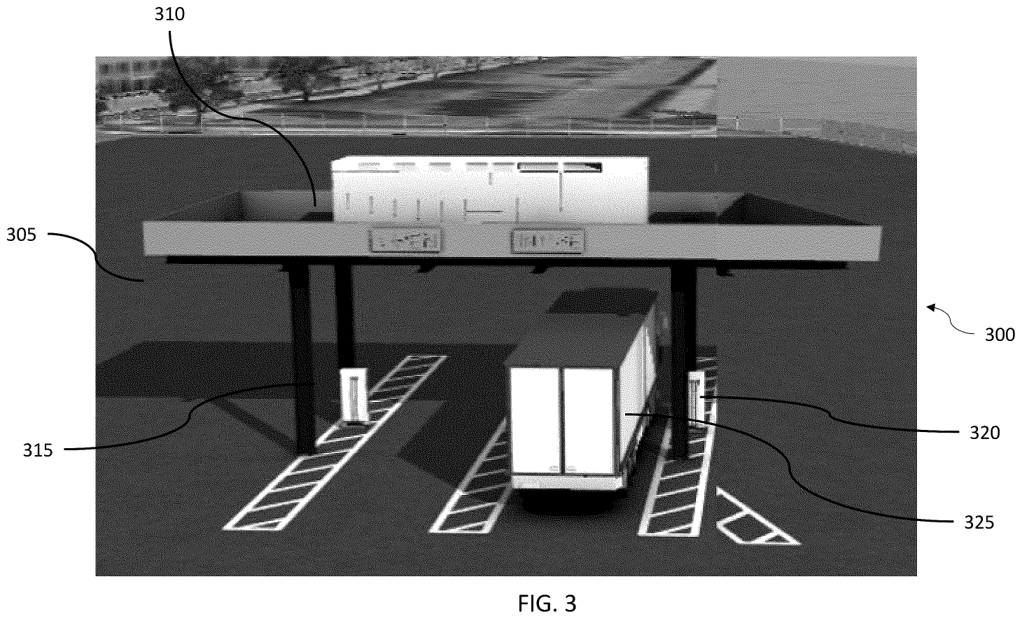

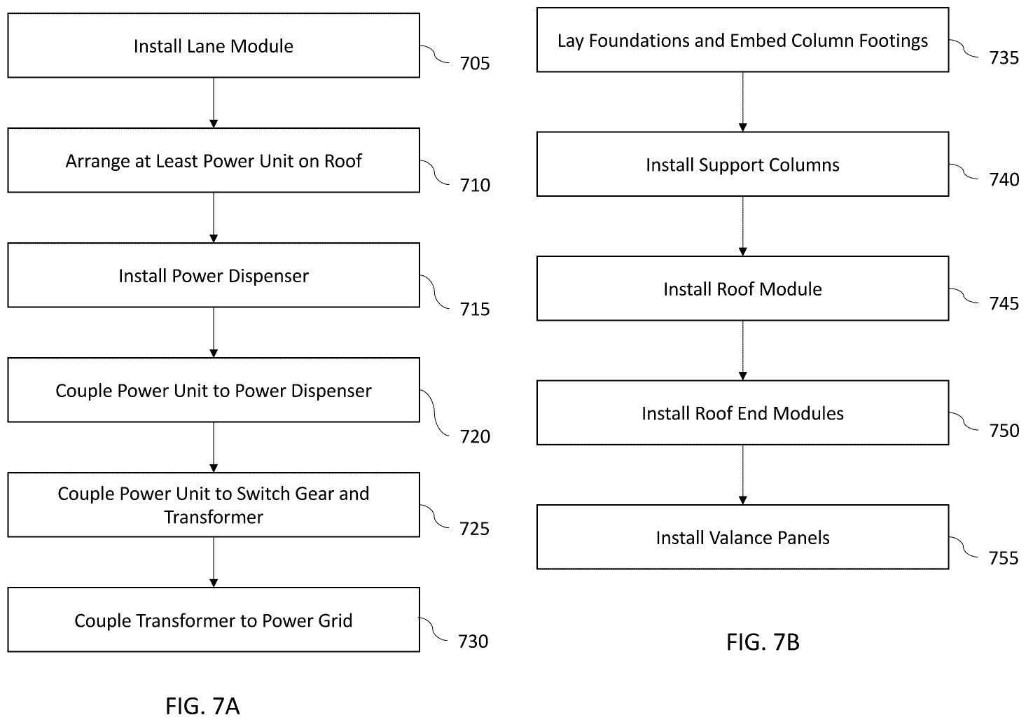

FIG. 3 illustrates a modular charging station 300, which includes at least one lane module 305 comprising a roof module 310 and at least two vertical support columns 315 (only one of which is labeled) coupling the roof module 310 to the ground. As will be discussed below in connection with FIGS. 7A-10L, the vertical support columns can include two vertical supporting structures that are attached to each other, the roof module, and the ground on each lateral side of the roof module 310 instead of the four distinct vertical supporting structures illustrated in FIG. 3.

The system 300 includes a switch gear (not specifically illustrated in FIG. 3) coupled to a power grid, a transformer (not specifically illustrated in FIG. 3) coupled to the switch gear and configured to reduce an alternating current line voltage, and a power unit (not specifically illustrated in FIG. 3) coupled to the transformer and configured to convert the lower voltage alternating current to direct current. The system 300 also includes at least one power dispenser 320 coupled to the power unit and configured to supply the direct current to a commercial vehicle 325. At least the power unit is arranged in on the roof module 310 and the at least one power dispenser 320 is arranged on the ground and underneath the roof module 310.

The at least two vertical support columns 315 have a vertical dimension extending higher than the height of the commercial vehicles. This can be achieved either based on the actual height of the commercial vehicles (e.g., most tractor-trailers have a relatively uniform height) or can be based on a typical height limit for highways (i.e., highways typically have height limits due to bridges passing over the road or the road passing underground).

In the illustrated embodiment, the transformer, switch gear, and power unit are an integrated component arranged in a common housing. In other embodiments, the power unit is arranged on the roof module along with the transformer and switch gear, and the transformer, switch gear, and power unit are separate components. Further, in other embodiments the power unit is arranged on the roof module and the transformer and switch gear are arranged on the ground, or the switch gear and power unit are arranged on the roof module and the transformer is arranged on the ground. In any of these embodiments, the components arranged on the roof module can be arranged in a common housing, regardless of whether or not the components are integrated or separate components.

At least one power line (not illustrated) is provided to couple the power unit (or the switch gear when the power unit is arranged in the power dispenser 320) to the power dispenser 320. The power line(s) can be arranged to pass through an opening in the roof module, then through one of the two vertical support columns, where the power line(s) exit through an opening in the bottom portion of the vertical support column. The power line is then coupled to the power dispenser 320. The power line exiting the vertical support column through an opening in the bottom portion can then have a short run along the ground and then is connected to the power dispenser 320. In other embodiments, the power dispenser 320 can be attached (or directly adjacent) to the vertical support column, in which case the power line can exit from the vertical support column and be coupled directly to the power dispenser 320, which avoids having the power cable exposed.

Depending upon the power needs of the commercial vehicles, a single transformer, single switch gear, and single power unit can be provided to support one or more power dispensers for each of the two lanes. However, in order to provide more power to each lane separate transformers, switch gears, and power units can be provided for each of the two lanes. Due to the structure of the disclosed modular charging station, it can be initially deployed a single transformer, single switch gear, and single power unit for power commercial vehicles in two lanes and can later be upgraded to provide more power to each lane by adding an additional transformer, switch gear, and power unit.

Moreover, a cooling unit (not illustrated) can be arranged on the roof module 310, either as a separate housing or in a common housing with one or more of the transformer, switch gear, and power units. Cooling lines can be provided from the cooling unit to the power dispenser 320. These cooling lines can be installed in a similar manner to that described in connection with the power line, i.e., passing through the roof module and one of the vertical support columns. This is particularly advantageous because a separate cooling unit is not required in each of the power dispensers 320, which reduces the costs and size of the power dispensers 320. The cooling unit can be any type of cooling unit that can receive a fluid, reduce the temperature of the fluid, and provide the reduced temperature fluid to the cooling lines, in a similar manner to a vehicle radiator.

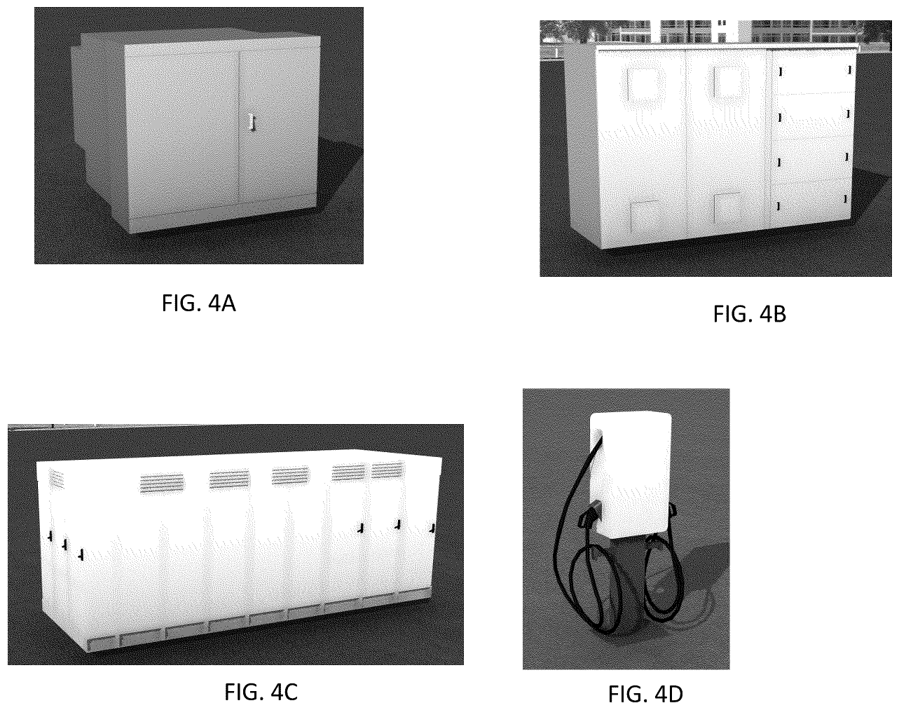

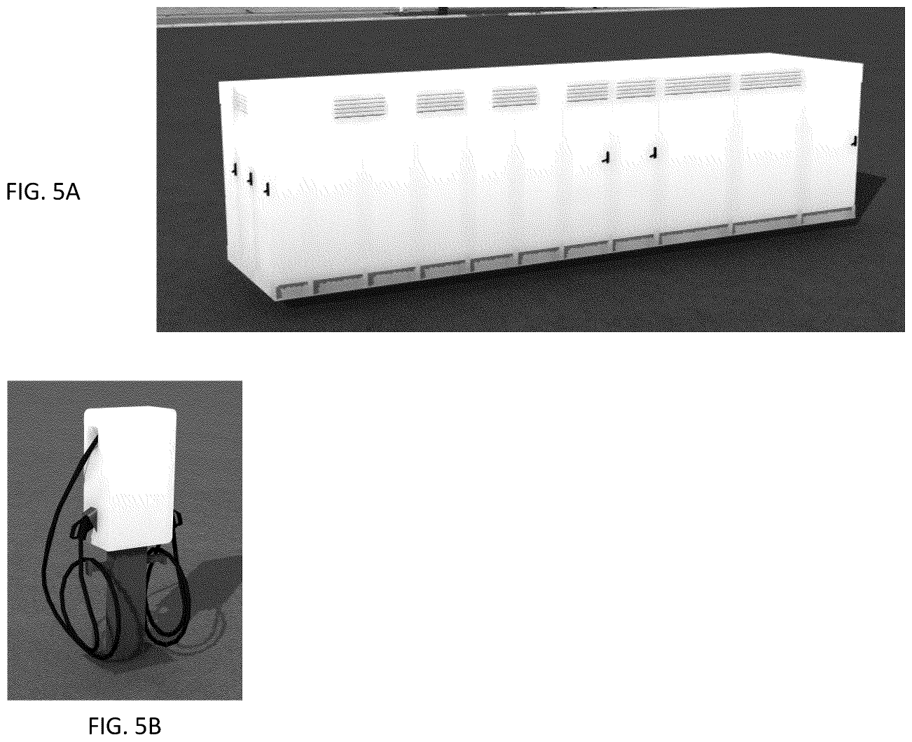

FIGS. 4A-4D and 5A and 5B, respectively illustrated different arrangement of the electrical components of the modular charging system. In FIGS. 4A-4C, the transformer (FIG. 4A), switch gear (FIG. 4B), and power unit (FIG. 4C) are separate components. At least the power unit is arranged on the roof module 310. Depending upon implementation, the transformer and switch gear are also arranged on the roof module 310. If desired, the components on the roof module can be in separate housings or in a common housing. FIG. 5A illustrates a unit that integrates the transformer, switch gear, and power unit into a single component that is installed on the roof module 310. This can be employed with the power dispenser 320 in FIG. 5B.

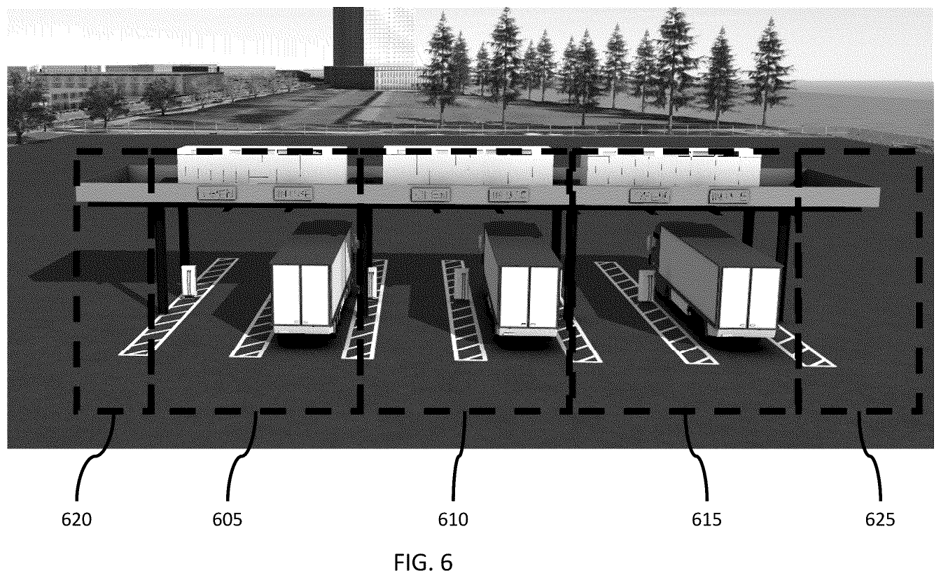

FIG. 6 illustrates a modular charging station that can simultaneously charge six commercial vehicles. As illustrated by the dashed squares, the modular charging station is comprised of three lane modules 605, 610, and 615 (each accommodating two lanes) and two roof end modules 620 and 625. Thus, as will be appreciated, the disclosed modular charging station can easily be configured and (as discussed in more detail below) reconfigured by adding lane modules to accommodate any number of lanes and corresponding charging dispensers.

FIG. 7A is a flowchart of a method for producing a modular charging station. At least one lane module 305, which comprises a roof module and at least two vertical support columns, is installed by affixing the at least two vertical support columns to ground and affixing the roof module on top of the at least two vertical support columns (step 705). At least the power unit, which converts alternating current power to direct current power, is arranged on the roof module 310 (step 710). At least one power dispenser is installed on the ground and underneath the roof module (step 715). The at least one power dispenser can be installed directly on the ground or on a foundation that is poured, which is described in more detail below in connection with FIG. 7B.

The power unit and the at least one power dispenser are electrically coupled to each other (step 720). A switch gear is electrically coupled to the power unit and a transformer is electrically coupled to the switch gear (step 725). The transformer is configured to reduce an alternating current line voltage from the power grid to a lower voltage alternating current and the switch gear is coupled to the transformer to receive the lower voltage alternating current. The transformer is electrically coupled to a power grid (step 730). Depending on the particular configuration, the transformer can be electrically coupled to a 480 V alternating current service or a primary voltage alternating current service (˜12-34.5 kV). Connection to the power grid can be overhead, directly to the roof, or underground and then led up one of the vertical support columns to the equipment on the roof.

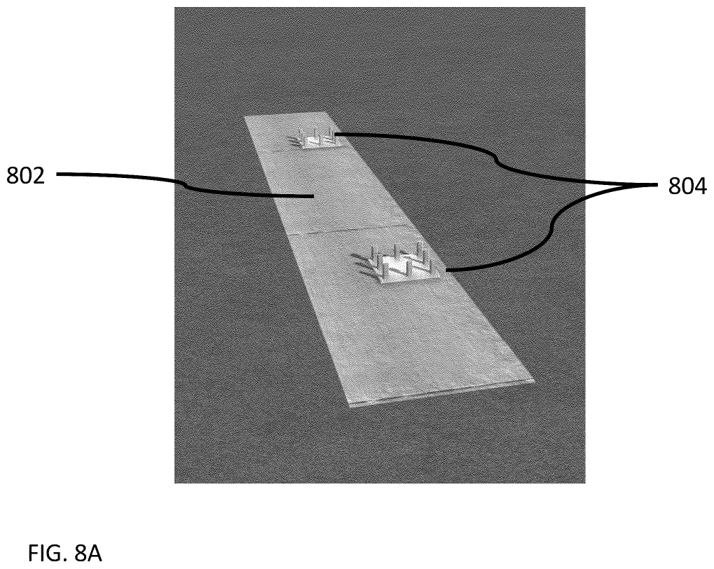

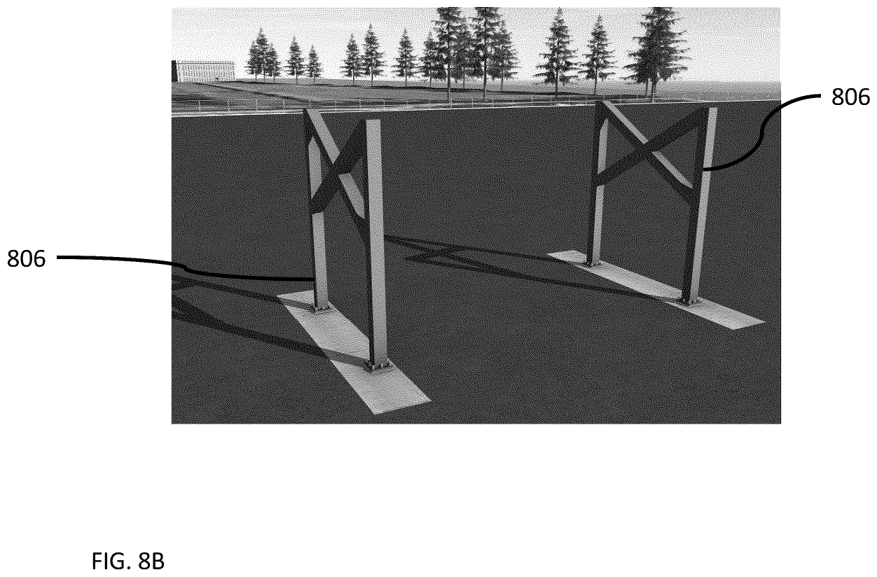

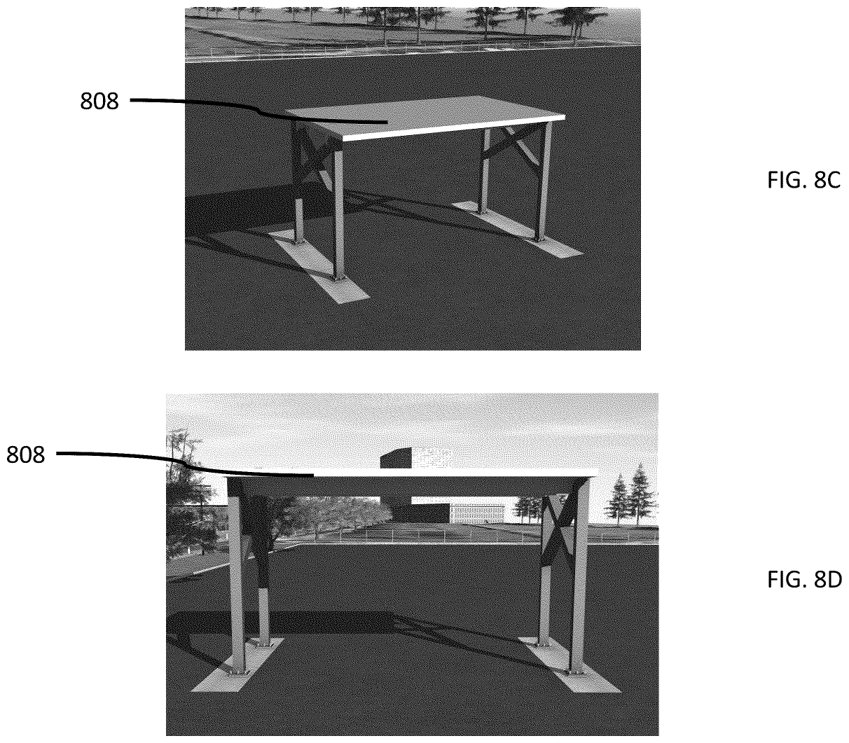

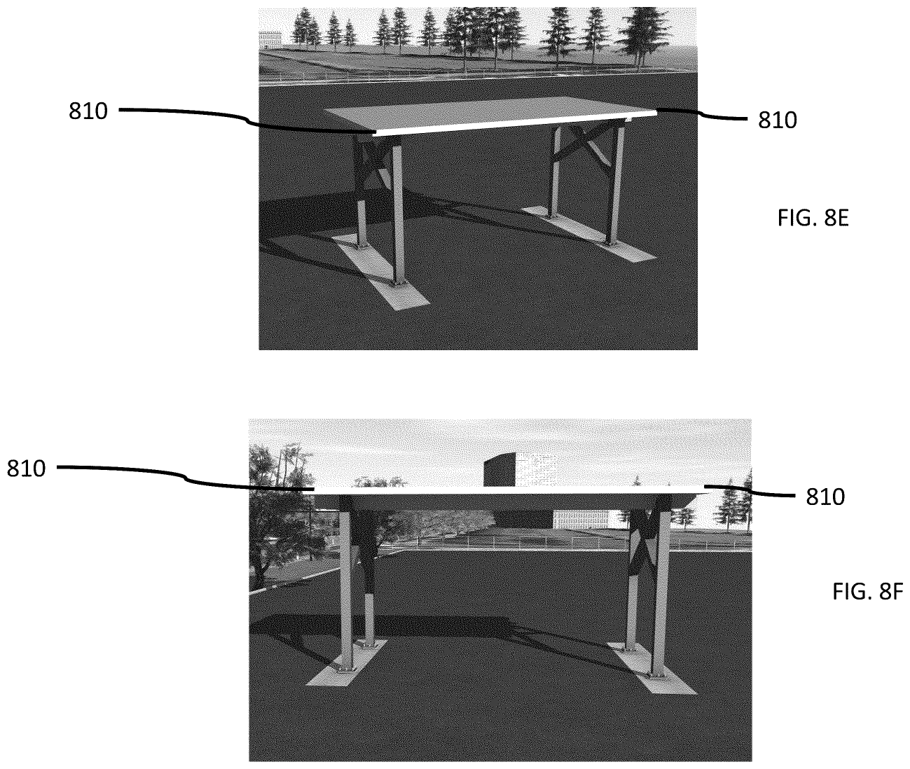

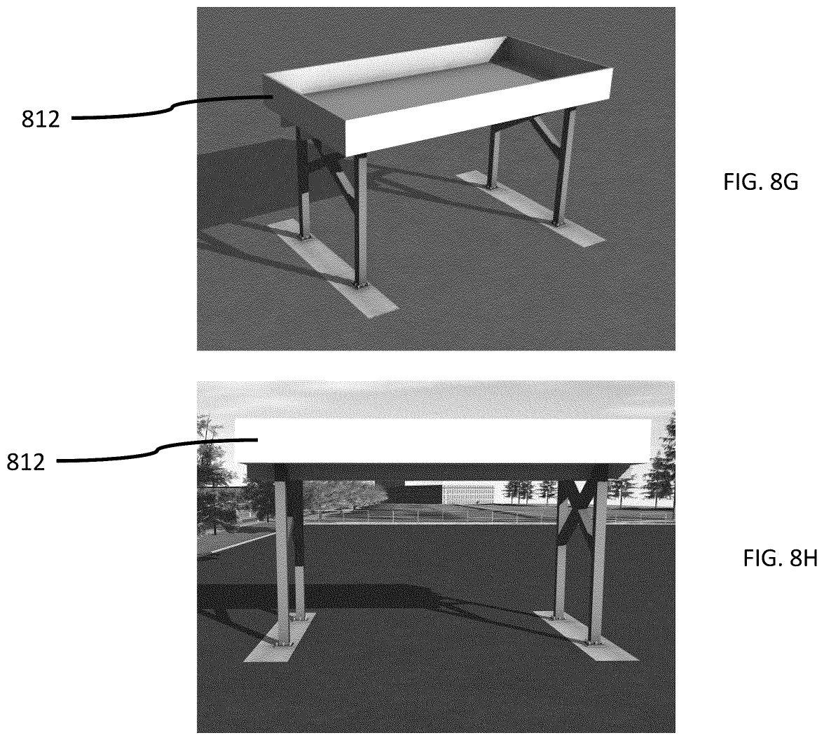

An exemplary implementation of the installation of the lane module in step 705 will now be described in connection with FIGS. 7B and 8A-8H. Initially, the foundations 802 (only one illustrated in FIG. 8A) are laid on the ground and the footings 804 are embedded in the foundations 802 (step 735). Specifically, a form is built (or a premade form is employed) and concrete is poured into the form and the footings 804 are installed in the wet concrete so that when the concrete dries it secures the footings 804 to the earth. After the concrete has sufficiently cured, vertical support columns 806 are installed on and fastened to the footings 804 (step 740 and FIG. 8B). The vertical support columns 806 illustrated in FIG. 8B provide two vertical supporting structures that are attached to each other, the roof module, and the ground. The vertical support columns, however, may be implemented in the manner illustrated in FIGS. 3 and 6 where four distinct vertical supporting structures are provided to support the roof module 808.

The roof module 808 is then installed on and secured to the support columns 806 (step 745 and FIGS. 8C and 8D). Roof end modules 810 are then installed on both lateral sides of the roof module 808 (step 750 and FIGS. 8E and 8F). As will be appreciated by comparing FIGS. 8C and 8D with FIGS. 8E and 8F, the roof module 808 slightly extends beyond the support columns 806 and the roof end modules 810 increase this extension in the lateral direction. Finally, the valence panels 812 (only one of which is labeled) are installed around the perimeter of the roof module 808 and roof end modules 810 (step 755 and FIGS. 8G and 8H). The valence panels are optional and can be designed to customer aesthetic requirements or legal requirements to obscure the equipment on the roof module from being seen from public view.

It should be recognized that the methods illustrated in FIGS. 7A and 7B can be performed in a different order than described. For example, the power dispenser can be installed before the power unit. Similarly, the power unit can be coupled to the power dispenser after the switch gear and transformer are coupled to each other. Further, the transformer can be coupled to the power grid earlier in the method, but at least after the transformer is coupled to the switch gear, because the switch gear acts as a circuit-breaker preventing the alternating current power from the grid from passing to other components coupled to the switch gear.

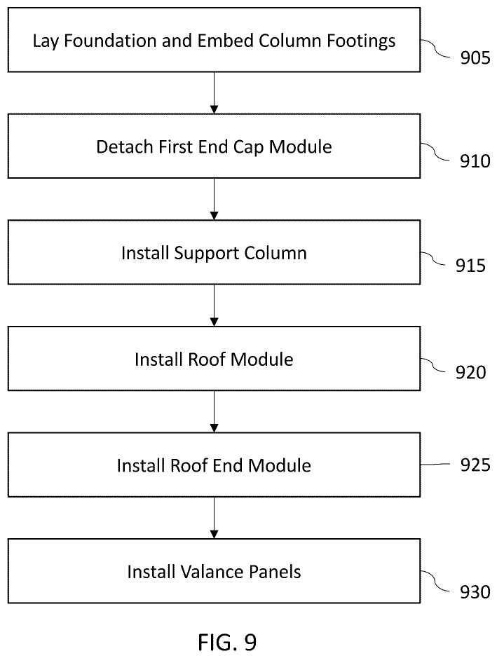

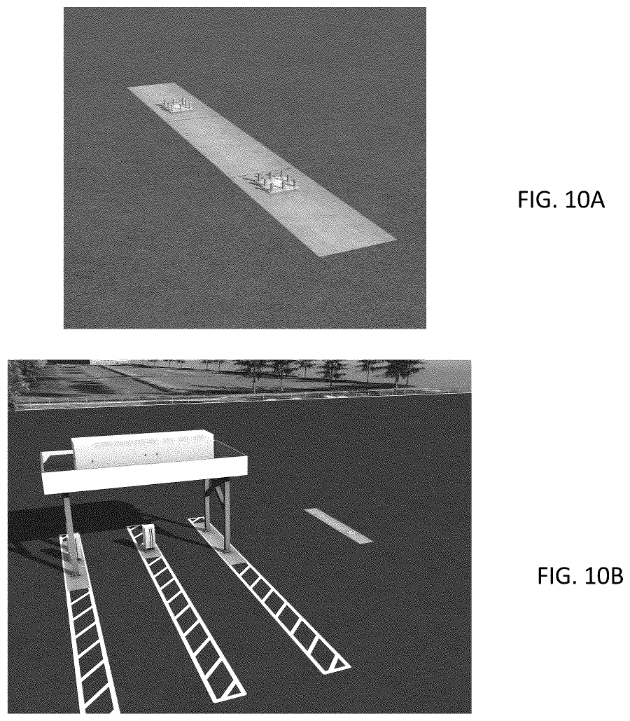

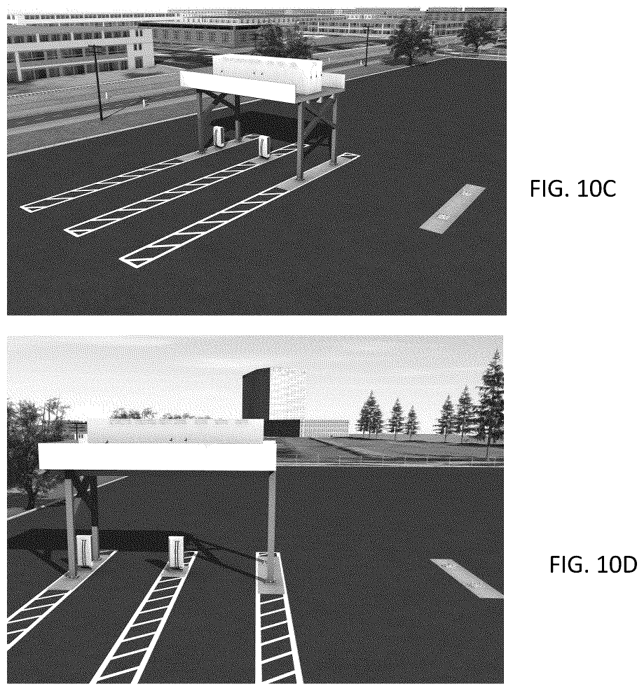

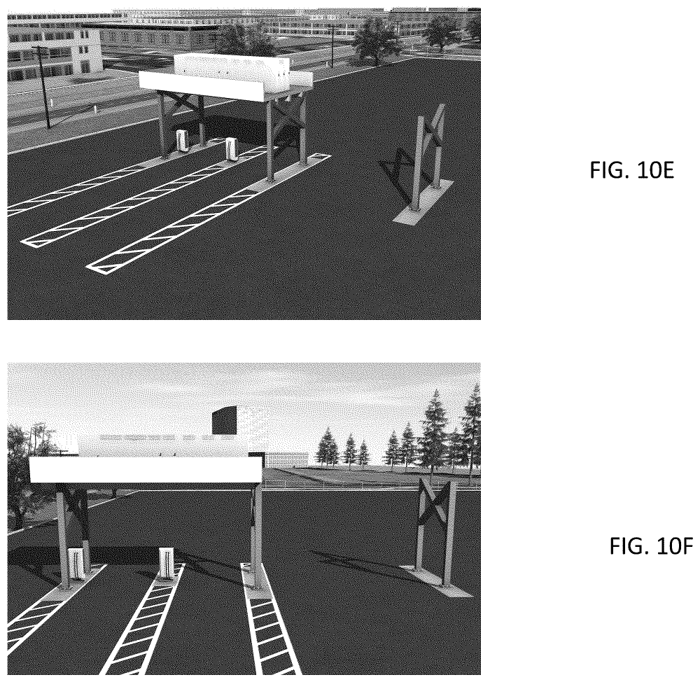

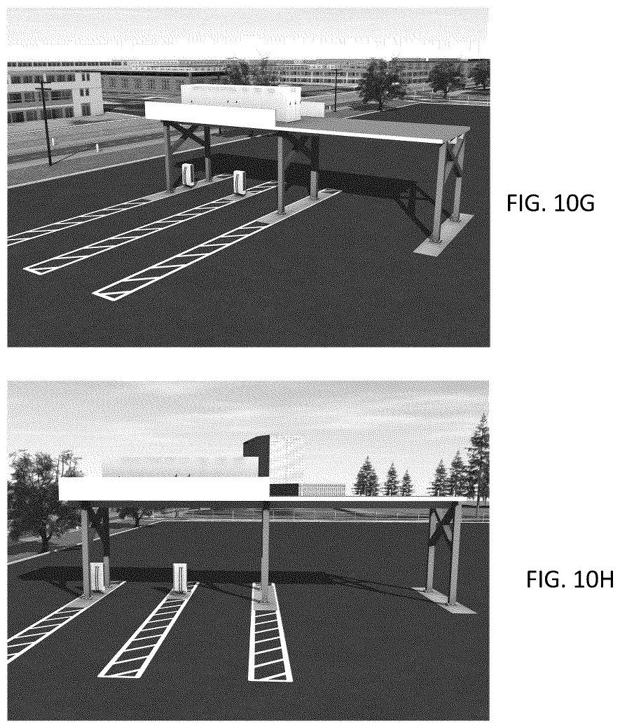

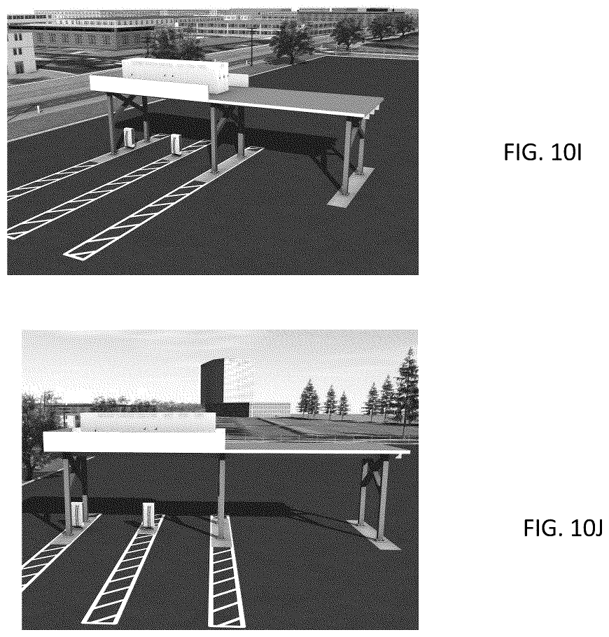

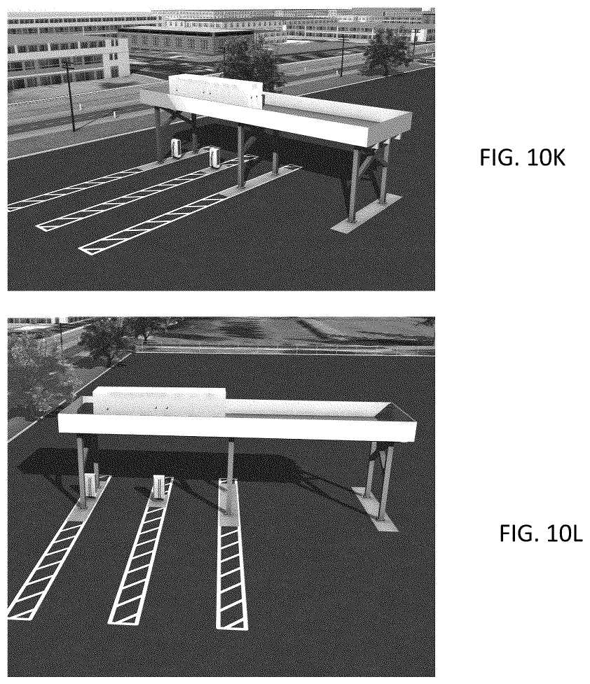

As mentioned above, the disclosed modular charging station allows for easy reconfiguration because one or both roof end modules can be removed, and additional lane modules can be attached to the existing lane modules and then the one or both roof end modules are reattached. Specifically, referring to the flowchart in FIG. 9, the foundation is laid, and the column footings are embedded in the foundation (step 905 and FIGS. 10A and 10B). The first roof end module is then detached from the first end of the roof (step 910 and FIGS. 10C and 10D). The support column for the extension is added (step 915 and FIGS. 10E and 10F). The roof module is then installed on the support column of the existing lane module and the newly installed support column (step 920 and FIGS. 10G and 10H). The roof end module that was removed (or a new roof end module depending upon the condition of the removed roof end module) is then attached to the open end of the roof module that was installed (step 925 and FIGS. 101 and 10J). Finally, the valence panels are installed so that the entire roof of the extended modular charging station has a relatively uniform appearance (step 930 and FIGS. 10K and 10L).

As will be appreciated, providing roof end modules that are distinct from the roof modules allows a relatively simple modular expansion of the charging station because a roof end module can be removed from one end of the roof, an extension roof can be added, and then the roof end module can be installed on the extended roof. Further, the expansion can be performed in a particular cost-effective manner because the extension roof is supported by one of the existing vertical support columns, and thus only one new foundation needs to be laid and one additional vertical support column needs to be added.

For ease of explanation and not limitation, it should be recognized that the steps in the method described in connection with FIG. 9 does not need to be performed in the particular order described. For example, the foundation can be laid after the first end cap module is detached.

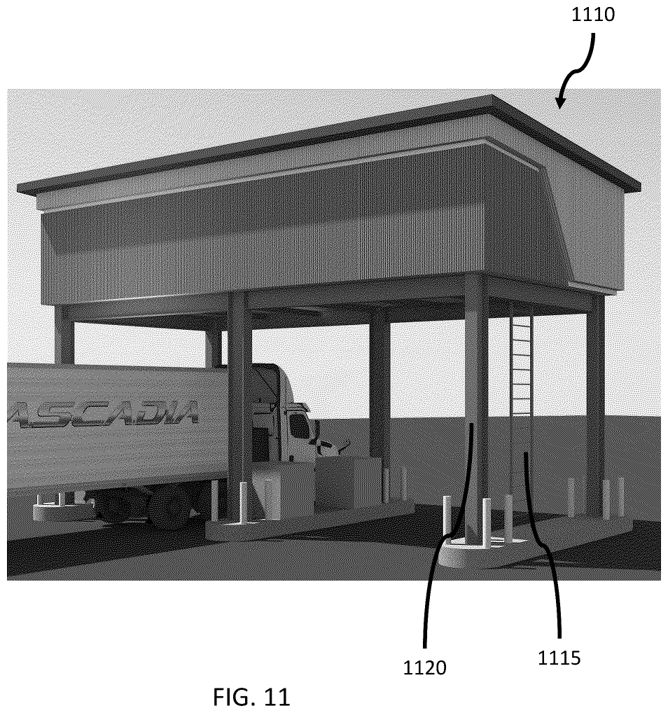

The embodiments described above involve a roof module having an open top and sides that only partially cover the equipment installed on the roof module. However, the roof module can also fully enclose the equipment installed on the roof module, examples of which will now be described in connection with FIGS. 11-15D.

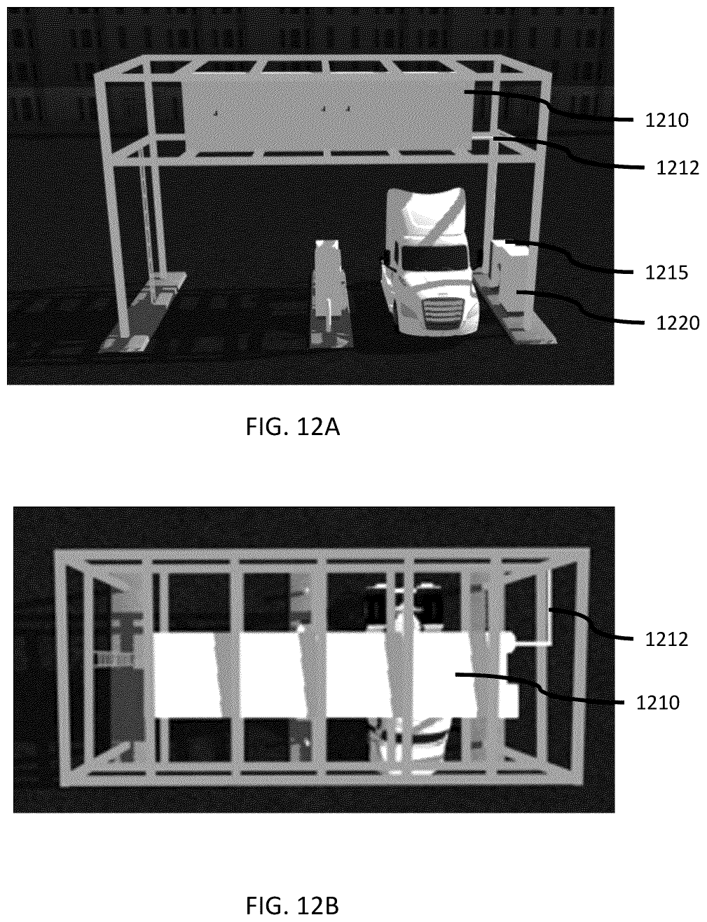

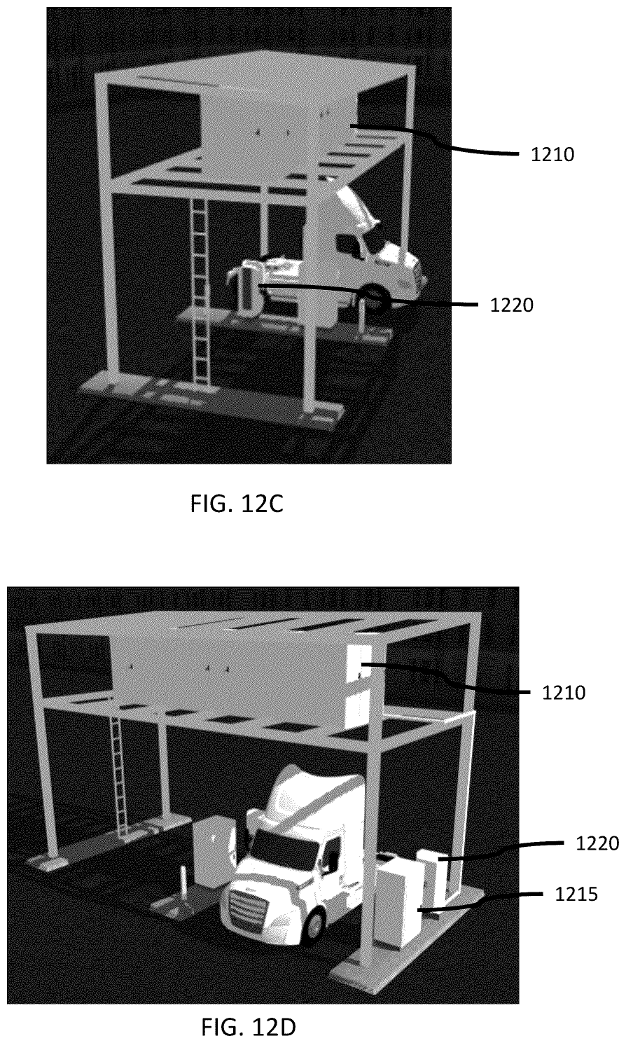

As illustrated in FIG. 11, the roof module 1110 is enclosed by sheathing on at least the four sides and the top. The sheathing used for the sides can be the same type or a different type of sheathing than the top. The sheathing can be metal, a metal composite, plastic, a plastic composite, and the like. Also illustrated in FIG. 11 is a ladder 1115 extending between the roof module 1110 and the ground to allow access to the area of the roof module 1110 containing various power equipment, which will be described in more detail below in connection with FIGS. 12A-15D. Depending upon local building codes, a staircase may be employed as an alternative to, or in addition to, the ladder. The top of the roof module 1110 can be arranged parallel to the ground or can be sloped to allow water to easily drain from the sheathing on the top of the roof module 1110. Similar to the earlier embodiments, the module charging station of FIG. 11 includes vertical support columns 1120 (only one of which is labeled for purposes of clarity) coupling the roof module 1110 to the ground.

The enclosed roof module 1110 can include venting (not illustrated) in the form of one or more vents to allow the dissipation of heat from within the enclosed roof module 1110. Further, a cooling unit (not illustrated) can be arranged in the enclosed roof module 1110 to cool the electrical equipment installed in the enclosed roof module 1110.

As discussed above, the various electrical equipment can be arranged in a variety of different manners, such as some electrical equipment being arranged in the roof module and other equipment on the ground. Various configurations of a modular charging station having an enclosed roof module as illustrated in FIG. 11 will now be described in connection with FIGS. 12A-15D in which the sheathing is not illustrated so that the components within the enclosed roof module can be seen.

In FIGS. 12A-12D the power unit and switch gear are arranged in a common housing 1210 within the enclosed roof module 1110. A cooling module 1215 is arranged on the ground and is fluidically coupled to the power dispenser 1220 in order to circulate cooling fluid to cool the power dispenser 1220. The power dispenser 1220 is also arranged on the ground. The cooling module 1215 and power dispenser are electrically coupled to the power unit via electrical lines 1212, which run down from the enclosed roof module 1110 to the ground along one of the supports of one of the pillars. It should be appreciated that the reference to electrical lines herein includes one or more lines capable of carrying electrical power, as well as electronic data for the various components to exchange data with one another to control the delivery of power to a commercial vehicle.

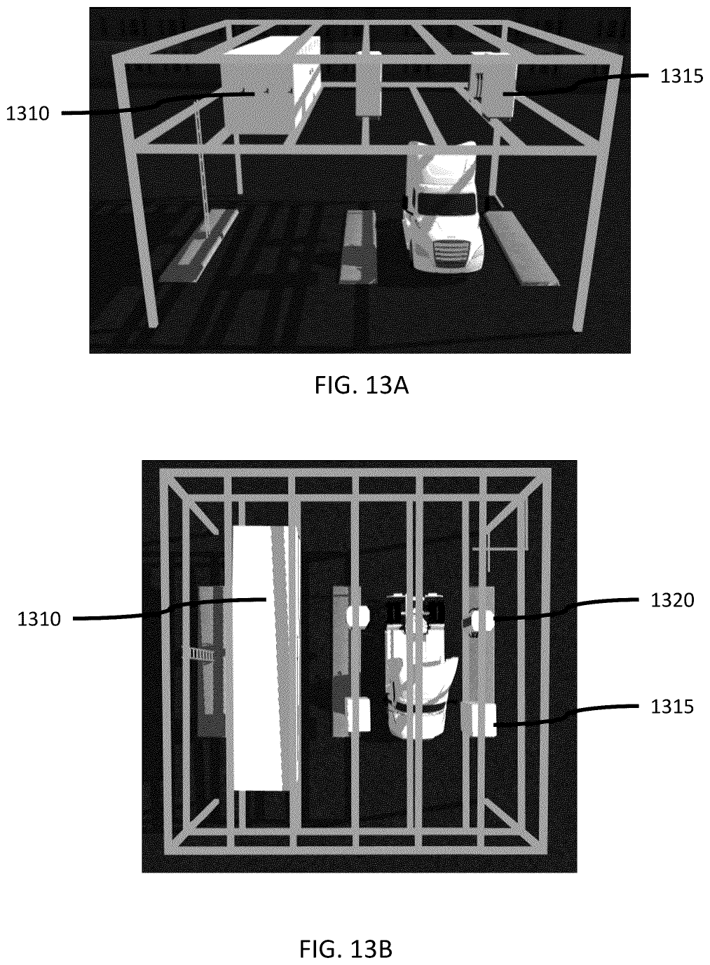

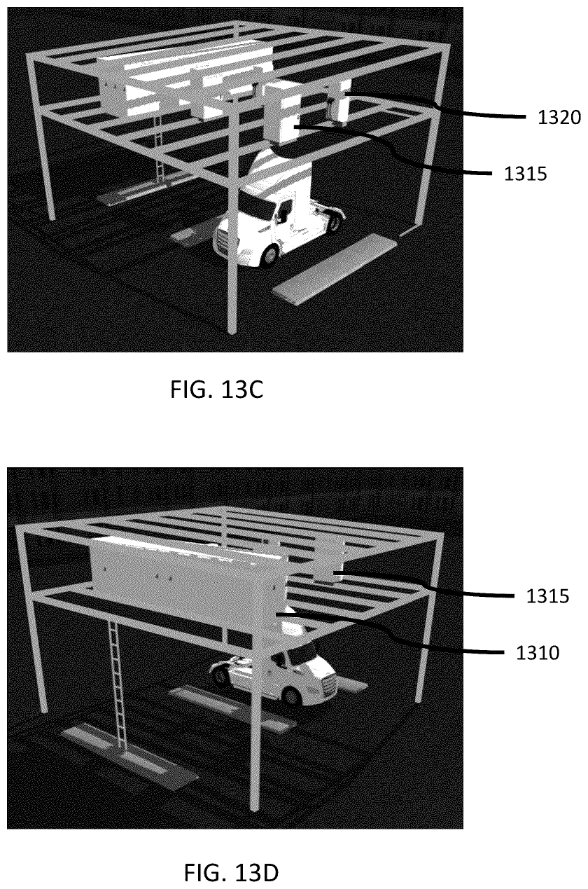

In FIGS. 13A-13D the power unit and switch gear are arranged in a common housing 1310, and is arranged within the enclosed roof module 1110 along with the cooling module 1315 and power dispenser 1320, which again are electrically coupled to deliver power and exchange data. A charging cable connecting the commercial vehicle to the power dispenser 1320 extends down through an opening in the floor of the enclosed roof module 1110. Arranging the cooling module 1315 and power dispenser 1320 in the enclosed roof module 1110 protects these components from environmental conditions, as well as intentional or inadvertent damage. In FIGS. 13A-13D each lane is provided with a separate cooling module 1315 and power dispenser 1320.

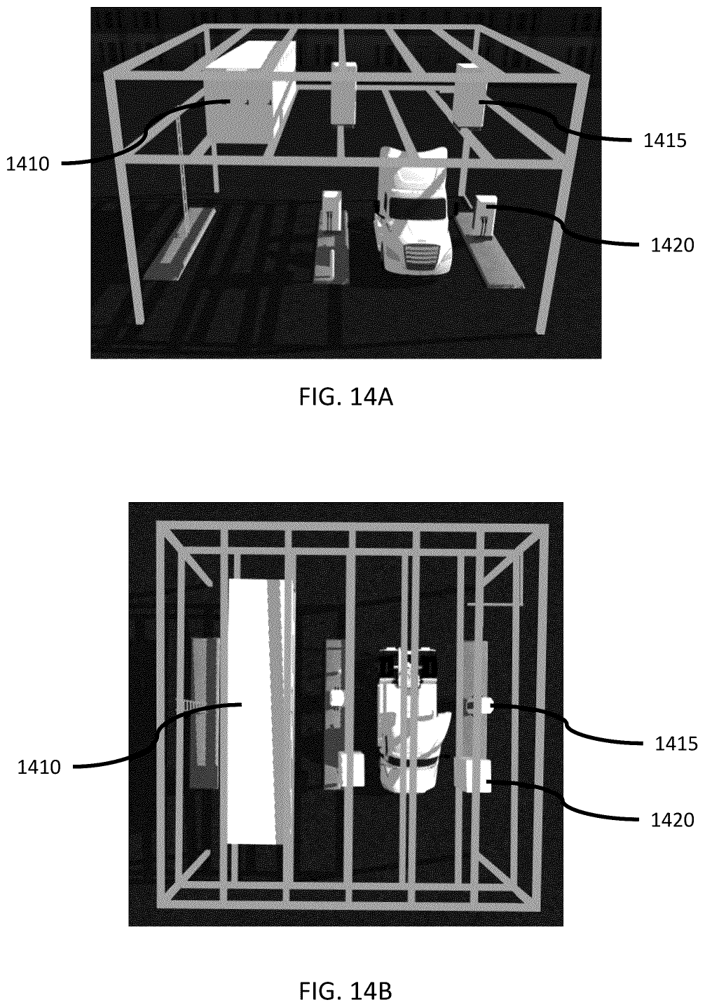

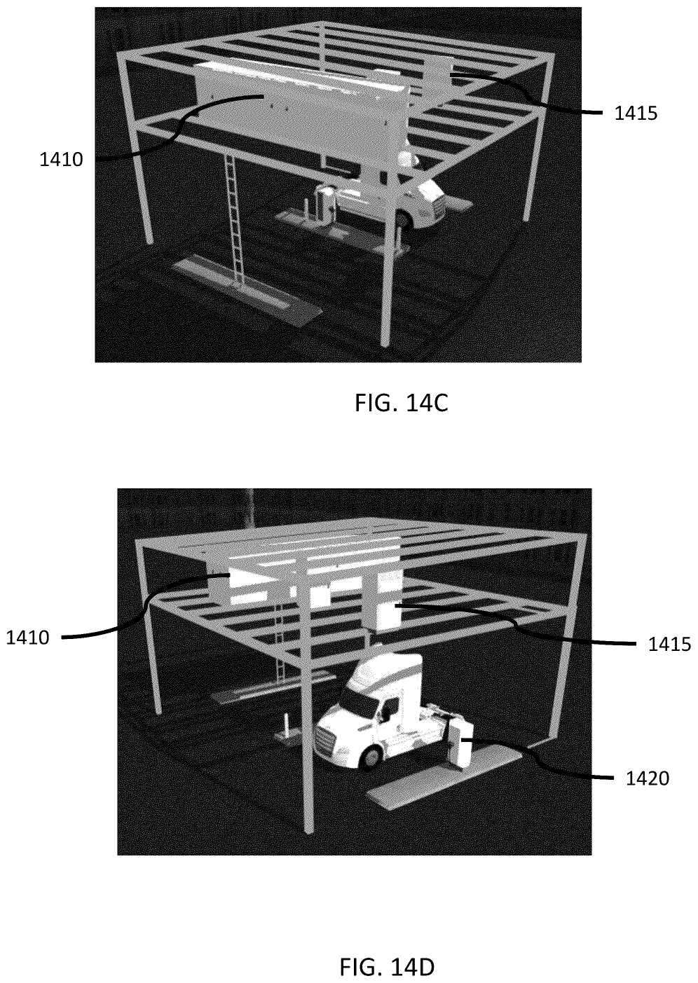

In FIGS. 14A-14D the power unit and switch gear are arranged in a common housing 1410, and are arranged within the enclosed roof module 1110 along with the cooling module 1415. The power dispenser 1420 is arranged on the ground and is electrically coupled to the power unit 1410 to exchange data to control operation of the power dispenser 1420. In FIGS. 14A-14D each lane has a power dispenser 1420 arranged on the ground and fluidically coupled to a corresponding cooling module 1415 installed on the roof module 1110.

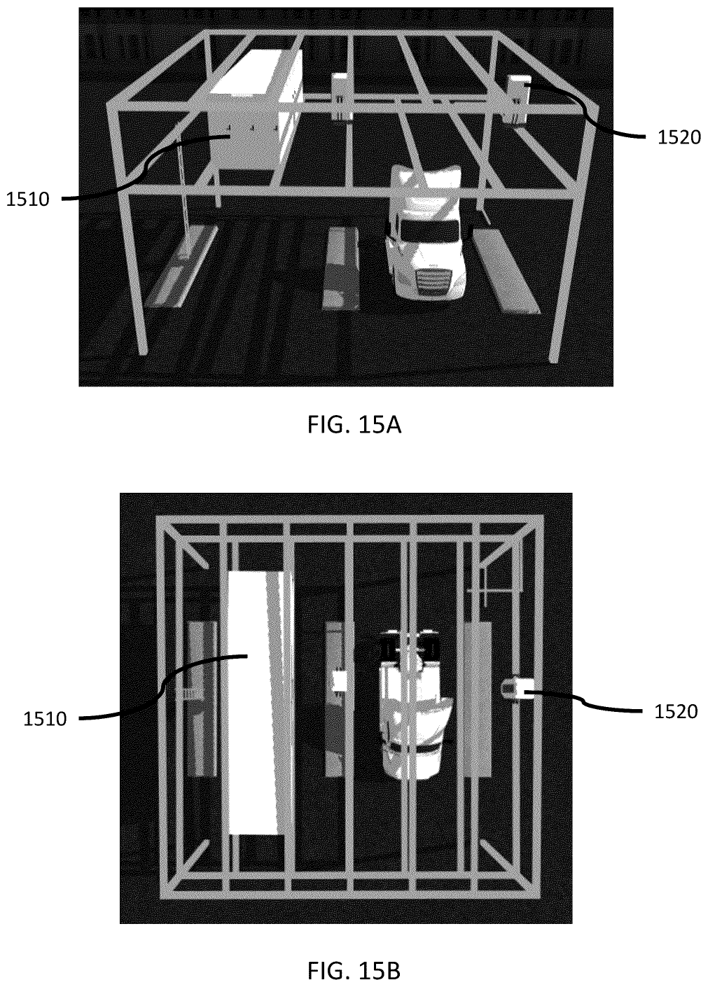

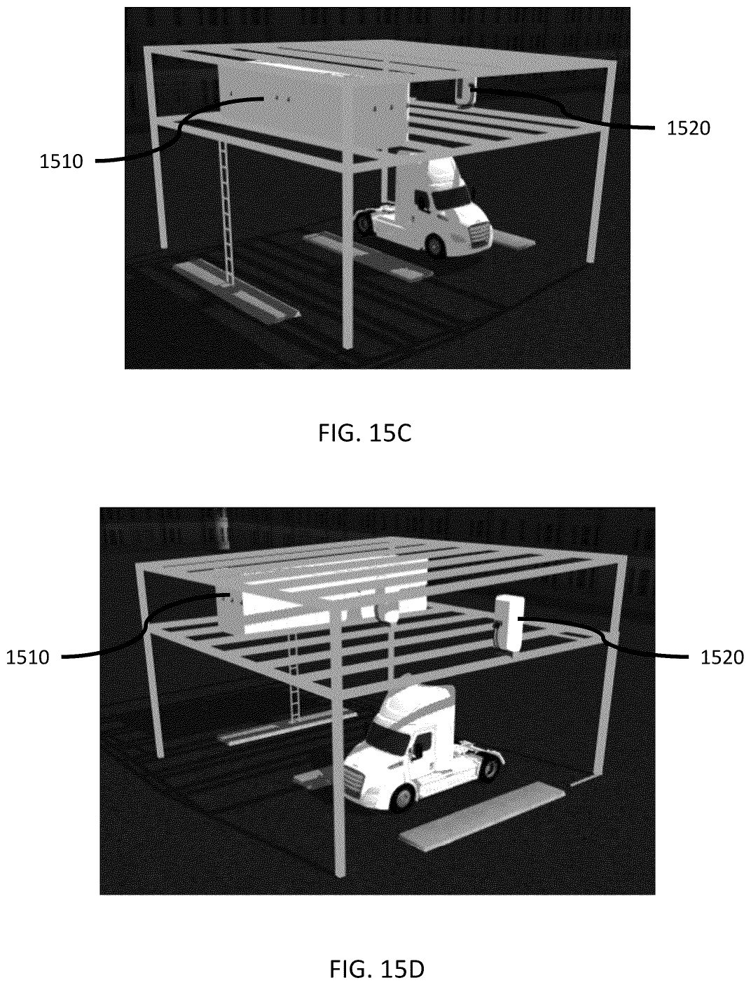

In FIGS. 15A-15D the power unit and switch gear are arranged in a common housing 1510, and is arranged within the enclosed roof module 1110. The power dispensers 1520 (one for each lane and only one labeled in the figures) are also arranged within the enclosed roof module and the respective charging cables connecting the commercial vehicle to the power dispenser 1520 extend down through an opening in the floor of the enclosed roof module 1110. In the system of FIGS. 15A-15D, one or more cooling modules can be arranged within the common housing 1510 along with the power unit and switch gear. Alternatively, each power dispenser 1520 can have an integrated cooling module. To the extent that the power dispensers 1520 can operate without exceeding critical temperatures affecting its operation, cooling modules for the power dispensers 1520 can be omitted. Again, the power dispensers 1520 are electrically coupled to the switch gear and power unit in order to power these components and exchange data to control the various components of the system.

The discussion of the power unit and switch gear being in a common housing in connection with FIGS. 11-15D should be understood as involving two separate components in a common housing, as well as a single component, such as a power unit with an integrated switch gear.

The modular charging stations illustrated in FIGS. 11-15D can be constructed in a similar manner to that described above in connection with FIGS. 7A-8H and expanded in a similar manner as described in connection with FIGS. 9-10L. The difference being that the roof module is enclosed at the top and the four lateral sides by sheathing after the various electrical equipment are installed on the roof module.

Those skilled in the art will recognize that in the systems described above if secondary voltage (i.e., 480 V) is employed by the system the connection of the switch gear to the power grid can be via a transformer operated by the power company and if primary voltage (i.e., 4 kV-34.5 kV) is employed by the system a transformer can be housed within (or integrated with) the power unit and electrically coupled between the switch gear and the power unit.

Although exemplary embodiments have been described involving obtaining electricity from a power grid, the disclosed modular charging station can also obtain electricity from other sources, such as solar, wind, a battery, etc. These sources can be coupled to the switch gear, which can then provide electricity to the power dispensers by selecting one or more electricity sources. For example, solar panels (and optionally a battery for storing energy from the solar panels) can be affixed to the roof of the lane module and/or of the roof end modules so that there is only a short cable run between solar panel and the switch gear. Because the solar panels can be placed on the roof of the modular charging station, these solar panels do not occupy any additional real estate beyond what is already required for the modular charging station powered by the electric grid.

As will be appreciated from the discussion above, the disclosed modular charging station addresses a number of limitations of conventional charging stations. Because the modular charging station positions at least the power unit, and possibly also the transformer and switch gear, on the roof of the lane module, the overall lateral size of the charging system is reduced, which increases flexibility in placement, particularly in areas with limited available space. Further, the modular charging station has a familiar aesthetic since people are used to seeing roofs on top of gasoline and diesel fuel pumps. Additionally, because the system is modular and the lane modules are of identical construction, expanding the charging station to accommodate additional commercial vehicles is relatively simple. Moreover, by avoiding running wires underground, upgrades are relatively simple and do not require trenching and the accompanying repair that would be required when the wires are run underground. By providing the valence panels as separate components from the roof modules, the roof modules can be efficiently packed for transport to the site of the modular charging station.

Furthermore, when a cooling unit is arranged on the roof of one of the lane modules, the cost and size of the power dispenser can be reduced as it no longer requires specialized cooling circuitry and components. Finally, the modular charging reduces the burden on the utility company because it only requires a direct connection between the transformer and the power grid.

The disclosed embodiments provide a modular charging station, a method for producing a modular charging station, and a method of modifying a modular charging station. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A modular charging station, comprising:
at least one lane module comprising a roof module and at least two vertical support columns coupling the roof module to ground;
a switch gear configured to receive alternating current voltage from a power grid;
a power unit configured to convert the alternating current voltage to a direct current voltage; and
at least one power dispenser coupled to the power unit and configured to supply the direct current voltage to a commercial vehicle,
wherein at least the power unit is arranged on the roof module.

2. The modular charging station of claim 1, wherein the switch gear is arranged on the roof module and the switch gear and power unit are in different housings.

3. The modular charging station of claim 2, further comprising:
at least one power line coupling the power unit to the at least one power dispenser, wherein the roof module includes an opening for the at least one power line, the at least one power line passes from the roof module through at least one of the at least two vertical support columns, and the at least one of the at least two vertical support columns includes an opening at a bottom portion opposite of the roof module so that the at least one power line exits the at least one of the at least two vertical support columns and is coupled to the at least one power dispenser.

4. The modular charging station of claim 3, further comprising:
a cooling unit arranged on the roof module;
cooling lines coupling the cooling unit to the at least one power dispenser, wherein the cooling lines pass through the opening in the roof module, the at least one of the at least two vertical support columns and exits at the bottom portion of the at least one of the at least two vertical support columns and is coupled to the at least one power dispenser.

5. The modular charging station of claim 1, wherein the switch gear is arranged on the roof module, and the switch gear and power unit are an integrated component arranged in a common housing.

6. The modular charging station of claim 5, further comprising:
at least one power line coupling the power unit to the at least one power dispenser, wherein the roof module includes an opening for the at least one power line, the at least one power line passes from the roof module through at least one of the at least two vertical support columns, and the at least one of the at least two vertical support columns includes an opening at a bottom portion opposite of the roof module so that the at least one power line exits the at least one of the at least two vertical support columns and is coupled to the at least one power dispenser.

7. The modular charging station of claim 6, further comprising:
a cooling unit arranged on the roof module;
cooling lines coupling the cooling unit to the at least one power dispenser, wherein the cooling lines pass through the opening in the roof module, the at least one of the at least two vertical support columns and exits at the bottom portion of the at least one of the at least two vertical support columns and is coupled to the at least one power dispenser.

8. The modular charging station of claim 1, further comprising:
first and second roof end modules, which are respectively configured for attachment to opposite ends of the roof module of the at least one lane module.

9. The modular charging station of claim 1, further comprising:
a transformer coupled to the switch gear and configured to reduce a voltage of the alternating current voltage to a lower alternating current voltage, wherein the transformer is integrated with the power unit.

10. The module charging station of claim 1, wherein the at least one power dispenser is arranged on the roof module.

11. The modular charging station of claim 1, wherein the roof module has a top and four lateral sides having sheathing enclosing the roof module.

12. A method for producing a modular charging station, the method comprising:
installing at least one lane module, comprising a roof module and at least two vertical support columns, by affixing the at least two vertical support columns to ground and affixing the roof module on top of the at least two vertical support columns;
arranging at least a power unit on the roof module, wherein the power unit converts an alternating current voltage to a direct current voltage;
installing at least one power dispenser on the ground and underneath the roof module;
electrically coupling the power unit and the at least one power dispenser to each other;
electrically coupling a switch gear to the power unit; and
electrically coupling the switch gear to a power grid so that the switch gear receives alternating current voltage from the power grid and provides the alternating current voltage to the power unit.

13. The method of claim 12, wherein the switch gear is arranged on the roof module and the switch gear and power unit are in different housings.

14. The method of claim 13, further comprising:
coupling, via at least one power line, the power unit to the at least one power dispenser, wherein the roof module includes an opening for the at least one power line, the at least one power line passes from the roof module through at least one of the at least two vertical support columns, and the at least one of the at least two vertical support columns includes an opening at a bottom portion opposite of the roof module so that the at least one power line exits the at least one of the at least two vertical support columns and is coupled to the at least one power dispenser.

15. The method of claim 14, further comprising:
arranging a cooling unit on the roof module; and
coupling, via cooling lines, the cooling unit to the at least one power dispenser, wherein the cooling lines pass through the opening in the roof module, the at least one of the at least two vertical support columns and exits at the bottom portion of the at least one of the at least two vertical support columns and is coupled to the at least one power dispenser.

16. The method of claim 12, wherein the switch gear is arranged on the roof module, and the switch gear and power unit are an integrated component arranged in a common housing.

17. The method of claim 16, further comprising:
coupling, via at least one power line, the power unit to the at least one power dispenser, wherein the roof module includes an opening for the at least one power line, the at least one power line passes from the roof module through at least one of the at least two vertical support columns, and the at least one of the at least two vertical support columns includes an opening at a bottom portion opposite of the roof module so that the at least one power line exits the at least one of the at least two vertical support columns and is coupled to the at least one power dispenser.

18. The method of claim 17, further comprising:
arranging a cooling unit on the roof module;
coupling, via cooling lines, the cooling unit to the at least one power dispenser, wherein the cooling lines pass through the opening in the roof module, the at least one of the at least two vertical support columns and exits at the bottom portion of the at least one of the at least two vertical support columns and is coupled to the at least one power dispenser.

19. The method of claim 12, further comprising:
attaching first and second roof end modules to first and second ends of the roof module, respectively.

20. The method of claim 19, further comprising:
detaching the first roof end module from the first end of the roof module;
installing a second lane module adjacent to the at least one lane module, wherein the second lane module comprises a second roof module and at least one second vertical support column and wherein the installation of the second lane module includes attaching the second lane module to the first end of the roof module of the at least one lane module and supporting the second roof module on one of the at least two vertical support columns of the at least one lane module; and
attaching the first roof end module to an end of the roof module of the second lane module that is opposite of an end of the roof module of the second lane module that is affixed to the first end of the roof module of the at least one lane module.
